(19) United States
(12) Patent Application Publication
(10) Pub. No.: US 2008/0113076 A1
(43) Pub. Date: May 15, 2008

(54) Method to Prepare a Stable High-Load Paprika Extract in Powder Form

(75) Inventor: Andreas Klingenberg, Reinbek (DE)

Correspondence Address: MICHAEL BEST & FRIEDRICH LLP, 100 E WISCONSIN AVENUE, Suite 3300, MILWAUKEE, WI, 53202, US

(73) Assignee: SENSIENT FOOD COLORS GERMANY GMBH & CO. KG, Geesthacht (DE)

(21) Appl. No.: 11/774,326

(22) Filed: Jul. 6, 2007

(30) Foreign Application Priority Data
Jul. 7, 2006 (DE) 20 2006 010 606.5

(51) Int. Cl. A23L 2/38

(52) U.S. Cl. 426/590; 426/660; 426/601

(57) ABSTRACT

The invention relates to a preparation for foodstuffs. It is proposed in this case that the preparation comprise at least a fat soluble dye, dispersed in a lipid-based carrier medium; polyglycerol esters of edible fatty acids; citric acid esters of monoglycerides and/or diglycerides of edible fatty acids; or mixtures of these esters; and starch sodium octenyl succinate.

### CROSS-REFERENCE TO RELATED APPLICATION

This patent application claims foreign priority to German Patent Application No. 20 2006 010 606.5, filed Jul. 7, 2006, the disclosure of which is incorporated by reference herein in its entirety.

### BACKGROUND OF THE INVENTION

The invention relates to a preparation for foodstuffs and a method for its manufacture. Is also relates to the use of such a composition.

Dyes have long been used in the food industry for the coloration of foodstuffs. These substances, which are designated as food dyes because of their intended use, are not, however, water soluble in many cases, but fat soluble. The use of fat-soluble substances in aqueous foodstuffs like juices is therefore not possible without further ado.

Carotenoids are a group of dyes, which are used to a large degree for the coloration of foodstuffs. These dyes are used, for example, in beverages, candies and yogurt preparations, but are also used in food supplements such as multivitamin tablets and for food for livestock. Carotenoids, however, are completely water insoluble. Intensive coloration of an aqueous beverage with this type of dye is only achieved if the dye is very finely dispersed in the aqueous beverage.

A colloidal distribution of the dye particles in an aqueous phase can be achieved by using emulsifiers. In addition, such a distribution can be permanently stabilized by adding stabilizers. The quantity of dye that can be emulsified and stabilized in an aqueous phase essentially depends upon the appropriate selection of emulsifiers and stabilizers. To achieve a satisfactory color saturation and to avoid opposing effects, the type of emulsifiers and stabilizers used must also be coordinated with one another carefully. Furthermore, the quantity of emulsifier and stabilizer should be as low as possible in relation to the quantity of the fat soluble dye. The quantity of fat soluble dye in an aqueous system that can be emulsified and stabilized according to the prior art is still unsatisfactory.

### DETAILED DESCRIPTION OF THE INVENTION

The objective of the invention is eliminating the disadvantages of the prior art. In particular, a preparation for foodstuffs is supposed to be disclosed that can be used to emulsify and stabilize a large quantity of fat soluble dye in an aqueous foodstuff.

This objective is attained by the features of claims 1, 19 and 20. Expedient embodiments of the invention are yielded from the features of claims 2 through 18, as well as 21 through 24.

According to the invention, a preparation for foodstuffs is provided, comprising at least

a fat soluble dye, dispersed in a lipid-based carrier medium;

polyglycerol esters of edible fatty acids; citric acid esters of monoglycerides and/or diglycerides of edible fatty acids; or mixtures of these esters; and

starch sodium octenyl succinate.

Polyglycerol esters of edible fatty acids (EC Number E-475) and citric acid esters of monoglycerides and/or diglycerides of edible fatty acids (EC Number E-472 c) are emulsifiers that are approved for use in foodstuffs.

Starch sodium octenyl succinate is a modified starch in accordance with EC Number E-1450, which is obtained by transforming starch with octenyl succinic anhydride. Consequently, it has a hydrophilic and lipophilic end and is used as a hydrocolloid in food technology to stabilize dyes among other things. Thus, starch sodium octenyl succinate is used as a stabilizer in the present invention.

The invention is based on the surprising discovery that, with a combination of the emulsifier in accordance with the invention with the stabilizer in accordance with the invention, the effect of the emulsifier in the dye-containing oil-in-water emulsion is not quashed, but instead the quantity of fat soluble dye, which is emulsified and stabilized in an aqueous system, can be increased considerably. In this way, considerably greater quantities of fat soluble dyes can be added to aqueous foodstuffs like beverages or yogurt products, thereby achieving better color saturation.

The fat soluble dye is preferably a food dye, particularly a dye, which is selected from the group comprising carotenoids, chlorophylls or combinations thereof. In an especially preferred embodiment, the fat soluble dye is a carotenoid. The carotenoid can be selected for example from the group comprising bixin, capsanthin, capsorubin, lutein, rhodoxanthin and combinations thereof.

Dyes in accordance with the invention also include, for example, the compounds listed under EC Numbers E160 (carotenoids), E160a (alpha- carotene, beta-carotene, gamma-carotene), E160b (bixin, norbixin, annatto, orlean), E160c (capsanthin), E160d (capsorubin), E160e (beta-apo-8′-carotenal), E160f (carotenal, carotenoic acid ethyl ester), E161 (xanthophylls), E161a (flavoxanthin), E161b (lutein), E161c (cryptoaxanthin), E161d (rubixanthin), E161e (violaxanthin), E161f (rhodoxanthin), E161g (canthaxanthin), as well as combinations of these compounds.

If the fat soluble dye is, for example, a carotenoid dispersed in a lipid-based carrier medium, then, when using only the hydrocolloid, but not the proposed emulsifiers, only approx. 5% by weight of the carotenoid dispersion, related to the total weight of a powdered, water-dispersible formulation, can be stabilized. The preparation in accordance with the invention, on the other hand, makes possible the stabilization of 15 to 20% by weight of the carotenoid dispersion, related to the total weight of a powdered, water-dispersible formulation and, thus, three to four times the quantity.

The increased concentration of the dye formulation with a dye, such as the carotenoid, for example, also affects liquid preparations. When using only the hydrogel, but not the proposed emulsifiers, a carotenoid dispersed in a lipid-based carrier medium can be stabilized with only approx. 2 to 3% by weight of the carotenoid dispersion, related to the total weight of a liquid, water-dispersible formulation. The preparation in accordance with the invention, on the other hand, makes possible the stabilization of 7 to 10% by weight of the carotenoid dispersion, related to the total weight of a liquid, water-dispersible formulation, and, thus, also three to four times the quantity.

The lipid-based carrier medium is preferably a vegetable triglyceride, for example, sunflower oil. The lipid-based carrier medium can contain additional additives like antioxidants. The portion of pure dye is between 10 and 35% by weight, related to the total weight of fat soluble dye and lipid-based carrier medium. The lipid-based carrier medium is designated in the following also as the oil phase.

According to the invention, the preparation contains as the emulsifier polyglycerol esters of edible fatty acids (E-475), citric acid esters of monoglycerides and/or diglycerides of edible fatty acids (E-472 c) or mixtures of E-475 and E-472 c. More detailed information on this subject can be found in Council Directive 78/663/EEC dated Jul. 25, 1978, laying down specific criteria of purity for emulsifiers, stabilizers, thickness and gelling agents for use in foodstuffs.

An edible fatty acid is a saturated fatty acid or an unsaturated fatty acid, which has been approved for use in foodstuffs. The edible fatty acid is preferably a fatty acid selected from the group comprising palmitic acid, stearic acid, oleic acid and erucic acid. The esterfied fatty acids can be the same or differ from one another.

The preparation can also contain other additives besides the dye, for example, antioxidants, tocopherol, ascorbic acid or combinations thereof.

The preparation is formulated preferably as a powder or as liquid.

The preparation as a powder preferably contains, related to the total weight of the preparation, respectively:
10 to 30% by weight of an oil phase containing the fat soluble dye;
1 to 10% by weight polyglycerol esters of edible fatty acids; citric acid esters of monoglycerides and/or diglycerides of edible fatty acids; or mixtures of these esters; and
60 to 85% by weight starch sodium octenyl succinate.

The preparation in accordance with the invention can further contain 1 to 7% by weight an antioxidants, tocopherol, ascorbic acid or combinations thereof.

The preparation as a powder preferably contains, related to the total weight of the preparation, respectively:
15 to 20% by weight of an oil phase containing the fat soluble dye;
0.5 to 5% by weight polyglycerol esters of edible fatty acids; citric acid esters of monoglycerides and/or diglycerides of edible fatty acids; or mixtures of these esters; and
70 to 80% starch sodium octenyl succinate.

This preparation in accordance with the invention can further contain 1 to 5% by weight of antioxidants, tocopherol, ascorbic acid or combinations thereof.

In the case of a formulation of the preparation as a liquid, it preferably contains, related to the total weight of the preparation, respectively:
5 to 15% by weight of an oil phase containing the fat soluble dye;
0.1 to 5% by weight polyglycerol esters of edible fatty acids; citric acid esters of monoglycerides and/or diglycerides of edible fatty acids; or mixtures of these esters;
20 to 60% by weight starch sodium octenyl succinate; and
30 to 70% by weight water.

The preparation in accordance with the invention can further contain 0.5 to 4% by weight of antioxidants, tocopherol, ascorbic acid or combinations thereof.

The preparation as a liquid preferably contains, related to the total weight of the preparation, respectively:
7 to 13% by weight of an oil phase containing the fat soluble dye;
1 to 3% by weight polyglycerol esters of edible fatty acids; citric acid esters of monoglycerides and/or diglycerides of edible fatty acids; or mixtures of these esters;
30 to 40% by weight starch sodium octenyl succinate; and
40 to 60% by weight water.

This preparation in accordance with the invention can further contain 1 to 3% by weight of antioxidants, tocopherol, ascorbic acid or combinations thereof.

The oil phase consists preferably of the fat soluble dye itself, as well as the lipid-based carrier media such as, e.g., vegetable triglycerides, which are protected from oxidation by the further addition of appropriate antioxidants. The portion of the pure dye in the oil phase is between 10 and 35% by weight.

The preparation in accordance with the invention is preferably manufactured by preparing the fat soluble dye in an oil phase and admixing starch sodium octenyl succinate and polyglycerol esters of edible fatty acids, citric acid esters of monoglycerides and/or diglycerides of edible fatty acids, or mixtures of these esters. The preparation can then be mixed with water, for example, in a ratio of 1 to 1 (weight of preparation to weight of water), whereby an aqueous formulation is obtained.

The preparation or the aqueous formulation can be used in foodstuffs.

Examples of these foodstuffs are candies, beverages, such as fruit drinks or fruit preparations, and yogurt products.

The invention shall be explained in the following on the basis of an example.

### EXAMPLE

The example describes the manufacturing of a preparation containing carotenoid in accordance with the invention in a liquid form (Steps 1 through 3) and powder form (Steps 1 through 4).

Manufacturing the Oil Phase:

70 g of a paprika extract E-160 c, which had a dye content of 15% by weight, as related to the paprika extract, was dispersed in 30 g sunflower oil while stirring vigorously. The mixture was heated with the addition of 10 g tocopherol and 3 g polyglycerol ester of edible fatty acids for 30 minutes at 70° C. while stirring vigorously and then tempered to 40° C.

2. Manufacturing the Water Phase:

520 g demineralized water were heated to 40° C., and 15 g ascorbic acid was added. Then within 10 minutes, 350 g starch sodium octenyl succinate was added to the mixture while stirring vigorously.

3. Homogenizing the Oil Phase into the Water Phase:

Over a period of 15 minutes at a temperature of 40° C., the entire oil phase was added step-by-step to the aqueous phase maintained while stirring vigorously, distributed via an Ultraturrax homogenizer and then finely dispersed by means of high-pressure homogenization at 300 bar.

4. Spray Drying to a Powdered Product:

The liquid preparation obtained in Step 3 was transformed by means of spray drying at 60 to 180° C. into a powdered preparation.

Results

100 g of the powdered preparation obtained in Step 4 contained 2.2% by weight of the dye content E-160c, related to the total weight of the preparation.

1. A preparation for foodstuffs, comprising
(a) a fat soluble dye, dispersed in a lipid-based carrier medium;
(b) polyglycerol esters of edible fatty acids; citric acid esters of mono- and/or diglycerides of edible fatty acids; or mixtures of these esters; and
(c) starch sodium octenyl succinate.

2. A preparation according to claim 1, wherein the fat soluble dye comprises a food dye.

3. A preparation according to claim 1, wherein the fat soluble dye is selected from the group comprising comprises at least one of carotenoids, chlorophylls and combinations thereof.

4. A preparation according to claim 1, wherein the fat soluble dye comprises a carotenoid.

5. A preparation according to claim 4, wherein the carotenoid comprises at least one of bixin, capsanthin, capsorubin, lutein, rhodoxanthin and combinations thereof.

6. A preparation according to claim 1, further comprising at least one of antioxidants, tocopherol, ascorbic acid and combinations thereof.

7. A preparation according to claim 1 the preparation being formulated as a powder or a liquid.

8. A preparation according to claim 1, wherein the lipid-based carrier medium comprises a vegetable triglyceride.

9. A preparation according to claim 8, wherein the lipid-based carrier medium comprises a sunflower oil.

10. A preparation according to claim 1, wherein the portion of fat soluble dye in the lipid-based carrier medium is 10 to 35% by weight, related to the total weight of the fat soluble dye and lipid-based carrier medium.

11. A preparation according to claim 1, the preparation being formulated as a powder and comprising, related to the total weight of the preparation,
(a) 10 to 30% by weight of an oil phase containing the fat soluble dye;
(b) includes 1 to 10% by weight polyglycerol esters of edible fatty acids; citric acid esters of monoglycerides and/or diglycerides of edible fatty acids; or mixtures of these esters; and
(c) 60 to 85% by weight starch sodium octenyl succinate.

12. A preparation according to claim 11, further comprising 1 to 7% by weight, related to the total weight of the preparation, of antioxidants, tocopherol, ascorbic acid and should be combinations thereof.

13. A preparation according to claim 11, comprising, related to the total weight of the preparations:
(a) 15 to 20% by weight of an oil phase containing the fat soluble dye;
(b) 0.5 to 5% by weight polyglycerol esters of edible fatty acids; citric acid esters of monoglycerides and/or diglycerides of edible fatty acids; or mixtures of these esters; and
(c) 70 to 80% by weight starch sodium octenyl succinate.

14. A preparation according to claim 13, further comprising 1 to 5% by weight, related to the total weight of the preparation, of antioxidants, tocopherol, ascorbic acid and combinations thereof.

15. A preparation according to claim 1, the preparation being formulated as a liquid and comprising, related to the total weight of the preparation:
(a) 5 to 15% by weight of an oil phase containing the fat soluble dye;
(b) 0.1 to 5% by weight polyglycerol esters of edible fatty acids; citric acid esters of monoglycerides and/or diglycerides of edible fatty acids; or mixtures of these esters;
(c) 20 to 60% by weight starch sodium octenyl succinate; and
(d) 30 to 70% by weight water.

16. A preparation according to claim 15, further comprising 0.5 to 4% by weight, related to the total weight of the preparation, of antioxidants, tocopherol, ascorbic acid and combinations thereof.

17. A preparation according to claim 15, comprising, related to the total weight of the preparation:
(a) 7 to 13% by weight of an oil phase containing the fat soluble dye;
(b) 1 to 3% by weight polyglycerol esters of edible fatty acids; citric acid esters of monoglycerides and/or diglycerides of edible fatty acids; or mixtures of these esters;
(c) 30 to 40% by weight starch sodium octenyl succinate; and
(d) 40 to 60% by weight water.

18. A preparation according to claim 17, further comprising 1 to 3% by weight, related to the total weight of the preparation, of antioxidants, tocopherol, ascorbic acid and combinations thereof.

19. A method to manufacture a preparation according to claim 1, comprising:
preparing the fat soluble dye in of an oil phase; and
admixing starch sodium octenyl succinate and polyglycerol esters of edible fatty acids, citric acid esters of monoglycerides and/or diglycerides of edible fatty acids, or mixtures of these esters.

20-24. (canceled)

25. A foodstuff comprising the preparation according to claim 1.

26. A candy, beverage or yogurt product comprising the preparation according to claim 1.

27. A fruit drink or a fruit preparation comprising the preparation according to claim 1.

28. The method according to claim 19, further comprising mixing the preparation with water.

29. The method according to claim 23 wherein 50% by weight of the preparation is mixed with 50% by weight water.
